(19) United States
(12) Patent Application Publication
(10) Pub. No.: US 2010/0015483 A1
(43) Pub. Date: Jan. 21, 2010

(54) Reaction gas temperature and humidity regulating module for fuel cell stack

(76) Inventor: Jefferson YS Yang, Orange, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 12/461,597

(22) Filed: Aug. 18, 2009

Related U.S. Application Data
(63) Continuation-in-part of application No. 10/933,269, filed on Sep. 3, 2004, now abandoned.

(51) Int. Cl. H01M 8/04

(52) U.S. Cl. 429/24; 429/26

(57) ABSTRACT

A device for regulating temperature and humidity of a reaction gas to be supplied to a fuel cell stack includes a temperature regulation section provided with a first gas guide board through which the reaction gas flows, a coolant guide board through which a coolant from the fuel cell stack flows and a first partition interposed between the first gas guide board and the coolant guide board for exchange of heat between the reaction gas and the coolant and a humidity regulation section coupled to the temperature regulation section with a second partition therebetween and comprised of a second gas guide board through which the temperature-regulated gas flows and a fluid guide board through which a fluid from the fuel cell stack and rich of water contents flows and a humidity exchange film interposed between the second gas guide board and fluid guide board to allow for exchange of water contents between the temperature-regulated gas and the fluid.

### CROSS-REFERENCES TO RELATED APPLICATIONS

This application is a continuation-in-part of Ser. No. 10/933,269, filed on Sep. 3, 2004 entitled “Reaction Gas Temperature and Humidity Regulating Module for Fuel Cell Stack”.

### FIELD OF THE INVENTION

The present invention relates generally to the field of fuel cells, and in particular to a device for regulating temperature and humidity of reaction gas of fuel cells, especially a fuel cell stack.

### BACKGROUND OF THE INVENTION

Fuel cells are an electro-chemical device that makes use of electrochemical reaction between a fuel, such as hydrogen, and an oxidizer, such as oxygen contained in the surrounding air, to generate electrical power. The fuel cells are advantageous in low contamination, high efficiency and high power density. Thus, developments and researches are intensively devoted to the fuel cell field for exploitation of the utilization thereof. A variety of fuel cells are available, among which proton exchange membrane fuel cell, abbreviated as PEMFC, is the most prospective one due to the advantages of low operation temperature, fast activation and high power density with respect to unit weight and volume.

A typical fuel cell stack is comprised of a number of membrane electrode assemblies (MEA). Each MEA comprises an anode catalyst layer, a high molecular proton exchange membrane and a cathode catalyst layer. A basic cell can be formed by coupling the MEA with a gas diffuser and a bipolar plate in an overlapping and stacked manner.

The operation of the fuel cells is dependent upon the proton exchange membrane that functions to convey hydrogen ions between the cathode and the anode of the fuel cell for the progress of the electro-chemical reaction. The performance of the fuel cells is heavily dependent upon the reaction conditions, such as operation temperature, humidity, hydrogen flow rate, and air flow rate. For example, the proper humidity must be maintained for the high molecular proton exchange membrane in order to provide a fuel cell stack of high performance.

Currently, to maintain proper operation humidity for the fuel cell, a humidifier is added in a supply pipe of reaction gas, which increases the relative humidity of the reaction gas flowing through the supply pipe. Such a humidity-regulated reaction gas is then supplied to the fuel cell. For example, in an air supply conduit through which air containing oxygen is driven by a blower toward the fuel cell, a humidifier is arranged in the supply conduit to add water to and thus increasing relative humidity of the air supplied through the conduit. Thus, the air may reach the fuel cell with proper relative humidity and the performance of the fuel cell can be maintained/enhanced.

On the other hand, a substantial amount of heat is generated in the fuel cell during the operation of the fuel cell. Such heat must be removed properly. Conventionally, liquid coolant, such as water, is employed in a cooling circuit for removal of such heat. In other words, water flows through a cooling conduit inside the fuel cell and removes the heat. For a typical fuel cell, the temperature of the water at a coolant outlet of the fuel cell is around 60-70° C. Recycle of such heat is of great interest for the application of the fuel cell.

It is also known in the industry to regulate the relative humidity of reaction gas by using the cooling water to operate the humidifier. This inevitably consumes a portion of the cooling water and replenishment of the cooling water has to be done periodically.

Techniques that recycle the heat generated during the operation of the fuel cell for improving the performance of the fuel cell are currently known. For example, the heat that is generated during the operation of he fuel cell is commonly employed to heat canisters that store hydrogen and in order to regulate the temperature of hydrogen supplied to the fuel cell. Although the temperature of reaction gas (hydrogen) has been regulated by using by-product (heat) of the fuel cell, none of the known techniques deal with regulation of both temperature and relative humidity of the reaction gas with “by-product” of the fuel cell.

Thus, the present invention is aimed to solve the problems of temperature and humidity regulation of a fuel cell by means of “by-products” of the fuel cell in order to provide an optimum operation of the fuel cell.

### SUMMARY OF THE INVENTION

Thus, a primary object of the present invention is to provide a fuel cell comprising a device for regulating temperature and humidity of reaction gas for the fuel cell whereby the fuel cell is operated at an optimum condition.

Another object of the present invention is to provide a device for properly regulating temperature and humidity of a reaction gas that is supplied to a fuel cell for maintaining optimum operation of the fuel cell.

A further object of the present invention is to provide a device that employs “by-products” of a fuel cell to regulate temperature and humidity of a reaction gas of the fuel cell whereby thermal energy of coolant of the fuel cell can be recycled and proper humidity of the fuel cell can be realized.

To achieve the above objects, in accordance with the present invention, there is provided a device for regulating temperature and humidity of a reaction gas to be supplied to a fuel cell stack, comprising a temperature regulation section comprised of a first gas guide board through which the reaction gas flows, a coolant guide board through which a coolant from the fuel cell stack flows and a first partition interposed between the first gas guide board and the coolant guide board for exchange of heat between the reaction gas and the coolant and a humidity regulation section coupled to the temperature regulation section with a second partition therebetween and comprised of a second gas guide board through which the temperature-regulated gas flows and a fluid guide board through which a fluid from the fuel cell stack and rich of water contents flows and a humidity exchange film interposed between the second gas guide board and fluid guide board to allow for exchange of water contents between the temperature-regulated gas and the fluid. The device allows for recycle and use of the thermal energy contained in the high temperature coolant discharged from the fuel cell stack and also allows for use of the water rich fluid from the chemical reaction of the fuel cell stack to regulate the temperature and humidity of the reaction gas so that an optimum operation of the fuel cell stack may be obtained without substantial additional expense for the conditioning the reaction gas. In addition, the coolant is guided back to the fuel cell through a closed loop and lose of the coolant can be neglected. No periodical replenishment of the coolant is necessary.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a fuel cell system incorporating a reaction gas temperature and humidity regulating device constructed in accordance with the present invention;

FIG. 2 is a perspective view of the reaction gas temperature and humidity regulating device of the present invention with inlet and outlet member detached;

FIG. 3 is a front view of the reaction gas temperature and humidity regulating device of the present invention;

FIG. 4 is a rear view of the reaction gas temperature and humidity regulating device of the present invention;

FIG. 5 is a top plan view of the reaction gas temperature and humidity regulating device of the present invention;

FIG. 6 is a side elevational view of the reaction gas temperature and humidity regulating device of the present invention;

FIG. 7 is a schematic block diagram of a fuel cell stack incorporating the reaction gas temperature and humidity regulating device of the present invention;

FIG. 8 is an exploded view of the reaction gas temperature and humidity regulating device in accordance with a first embodiment of the present invention;

FIG. 9 is a cross-sectional view of a temperature regulation section of the reaction gas temperature and humidity regulating device of the present invention, serving a basic unit;

FIG. 10 is a cross-sectional view of a temperature regulation section of the reaction gas temperature and humidity regulating device in accordance with a second embodiment of the present invention, comprised of two basic units as illustrated in FIG. 9 stacked together;

FIG. 11 is a cross-sectional view of a humidity regulation section of the reaction gas temperature and humidity regulating device of the present invention, serving a basic unit;

FIG. 12 is a cross-sectional view of a humidity regulation section of the reaction gas temperature and humidity regulating device in accordance with a second embodiment of the present invention, comprised of two basic units as illustrated in FIG. 11 stacked together;

FIG. 13 is a schematic view showing a reaction gas temperature and humidity regulating stack composed of a plurality of temperature regulation sections and a plurality of humidity regulation sections in accordance with a third embodiment of the present invention;

FIG. 14A is an exploded view showing two temperature regulation sections are stacked in accordance with the third embodiment shown in FIG. 13;

FIG. 14B is an exploded view showing two humidity regulation sections are stacked in accordance with the third embodiment shown in FIG. 13;

FIG. 15 is a schematic view showing a reaction gas temperature and humidity regulating stack composed of a plurality of stacked temperature and humidity regulation devices in accordance with a fourth embodiment of the present invention;

FIG. 16A is an exploded view showing a temperature regulation section and a humidity regulation section are stacked in accordance with the fourth embodiment shown in FIG. 15; and

FIG. 16B is an exploded view showing another temperature regulation section and a humidity regulation section are stacked in accordance with the fourth embodiment shown in FIG. 15.

### DETAILED DESCRIPTION OF PREFERRED EMBODIMENTS

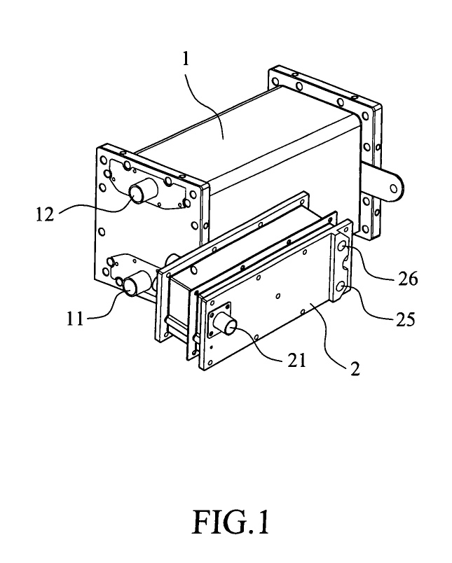

With reference to the drawings and in particular to FIG. 1, a fuel cell system in which the present invention is embodied comprises a fuel cell stack 1 and a reaction gas temperature and humidity regulating device constructed in accordance with the present invention, generally designated with reference numeral 2, which is coupled to the fuel cell stack 1 to regulate temperature and humidity of a reaction gas that is then supplied to the fuel cell stack 1. Preferably, the reaction gas temperature and humidity regulating device 2 of the present invention is firmly mounted to a selected side of the fuel cell stack 1. As is known, two reaction gases, namely hydrogen and oxygen, are required in order to perform the chemical reaction inside the fuel cell stack 1. Although hydrogen is supplied in a pure form from a canister, oxygen is supplied to the fuel cell stack in the form of regular air obtained from the surroundings. In the following description, air is taken as an example of the reaction gas for simplicity, yet it is apparent to those having ordinary skills to employ the present invention is other reaction gas for fuel cells.

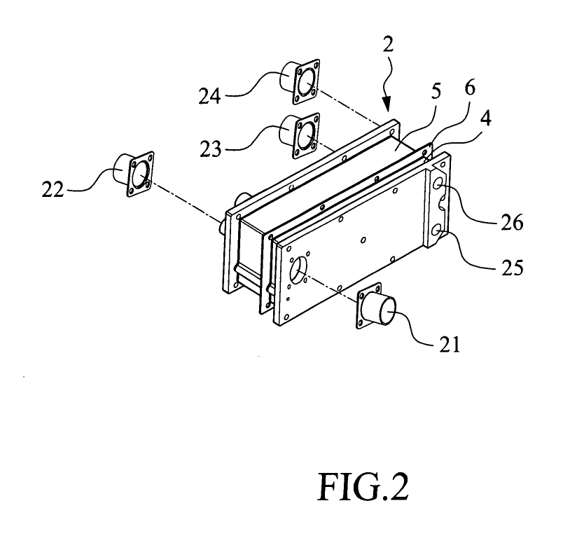

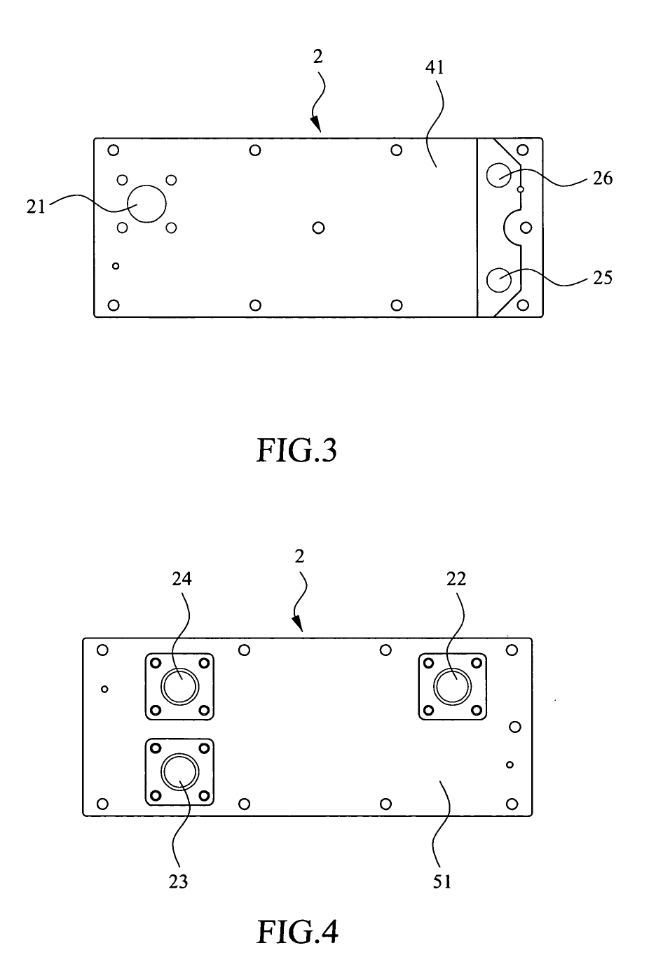

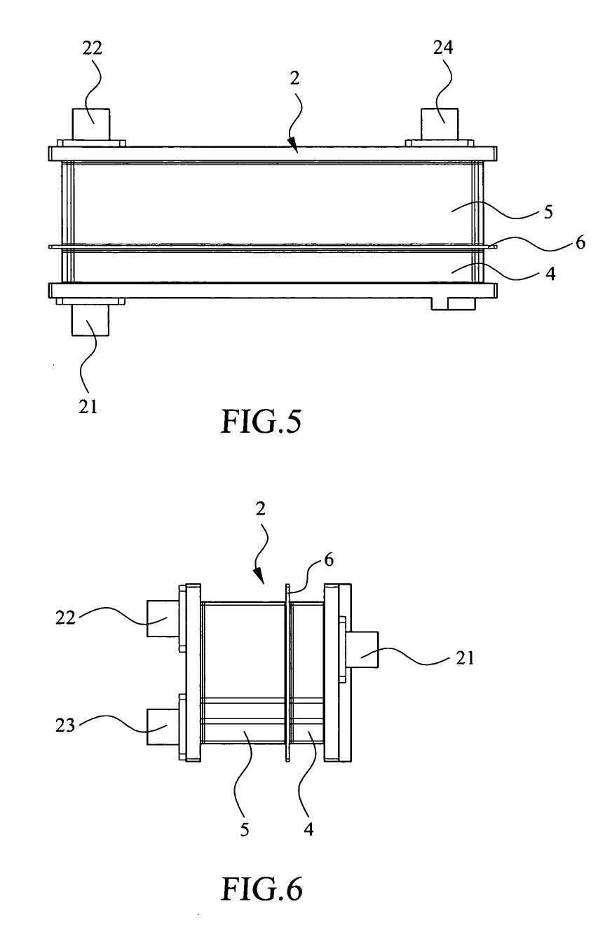

Also referring to FIGS. 2-6 and 8, the reaction gas temperature and humidity regulating device 2, which will be abbreviated as “the regulating device” hereinafter, comprising a main body (not labeled) having first and second end boards 41, 51 defining a first entry opening 411, a device-side coolant inlet 25, and a device-side coolant outlet 26 and a first exit opening 511, a second entry opening 512, and a second exit opening 513, respectively. A first inlet fitting 21 is mounted to the first end board 41 to be in fluid communication with the first entry opening 411. A first outlet fitting 22 is mounted to the second end board 51 to be in fluid communication with the first exit opening 511. Second inlet and outlet fittings 23, 24 are mounted to the second end board 51 to be in fluid communication with the second entry and exit openings 512, 513, respectively. The openings 411, 511, 512, 513 will be further described.

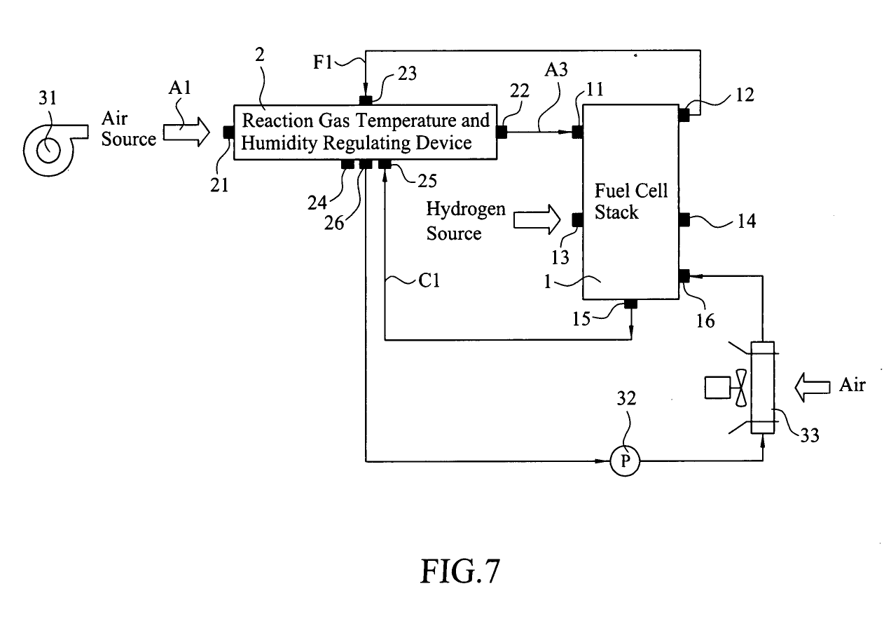

Also referring to FIG. 7, a fuel cell system comprised the fuel cell stack 1 and the regulating device 2 in accordance with the present invention comprises a coolant circulation loop and a gas circulation loop connected between the fuel cell stack 1 and the regulating device 2, as well as air supply and hydrogen supply. The air supply comprises a blower 31 that drives reaction gas A1(air) from the surroundings into the regulating device 2 through the first inlet fitting 21. The reaction gas A1 is then regulated by the regulating device 2 to have desired temperature and humidity. The temperature-regulated and humidity-regulated air A3 is supplied through the first outlet fitting 22 to an air inlet 11 of the fuel cell stack 1.

The hydrogen supply comprises a hydrogen source of any suitable form, such as a hydrogen canister that store hydrogen in solid form. Hydrogen from the canister is directly supplied to the fuel cell stack 1 through a hydrogen inlet 13. Excessive hydrogen is discharged from the fuel cell stack 1 through a hydrogen outlet 14.

The fuel cell stack 1 also comprises an air outlet 12 through which a fluid F1, which can be a reaction product, is discharged from the fuel cell stack 1. Such a fluid F1 is rich of water contents and is conducted to the second inlet fitting 23 of the regulating device 2, serving as a humidity source for regulating the humidity of the air flowing through regulating device 2. This constitutes the gas circulation loop.

In the coolant circulation loop, coolant C1 that cools the fuel cell stack 1 flows out of the fuel cells stack 1 through a cell-side coolant outlet 15 of the fuel cell stack 1. The coolant C1 that flows out of the cell-side coolant outlet 15 is at a high temperature around 60-70° C. The high temperature coolant is guided to the device-side coolant inlet 25 and enters the regulating device 2 for regulating the temperature of the air flowing through the regulating device 2. When the coolant C1 flows through the regulating device 2, the coolant C1, serving as a heat source, exchanges heat with the reaction gas A1 and thus the temperature of the coolant is lowered down. The coolant C1 that flows through the regulating device 2 is discharged to a pump 32 through the device-side coolant outlet 26. The pump 32 forces the coolant C1 through a heat dissipation device 33, such a heat radiator, through which heat is further removed from the coolant to bring the temperature of the coolant down to a desired low value. Such a low temperature coolant is then fed back into the fuel cell stack 1 through a cell-side coolant inlet 16 for once again removing heat from the fuel cell stack 1.

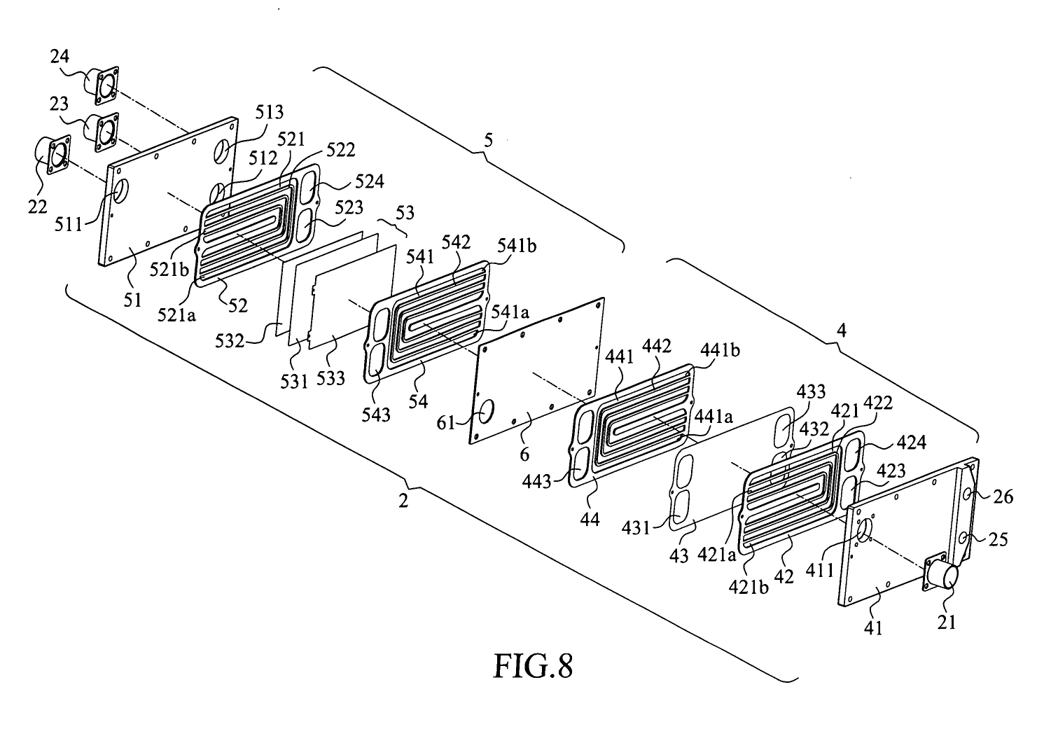

Particularly referring to FIG. 8, the main body of the regulating device 2 is comprised of a temperature regulation section 4 and a humidity regulation section 5 between which a central partition board 6 is interposed. The temperature regulation section 4, the central partition board 6, and the humidity regulation section 5 are secured together in a sandwich form by fasteners, such as bolts (not shown), with the end boards 41, 51 exposed.

The temperature regulation section 4 comprises the first end board 41 that is arranged opposite to the central partition board 6 with a first gas guide board 42, a temperature regulation side partition board 43 and a coolant guide board 44 interposed in sequence therebetween. The first gas guide board 42 forms at least one first gas channel 421, which in the embodiment illustrated comprises four U-shaped channels that are spaced by isolation ribs 422 and are of segments substantially parallel to each other. The U-shaped channel 421 has a first end 421a corresponding in position to the first entry opening 411 of the first end board 41 and a second end 421b. The first gas guide board 42 also defines a first coolant passage 423 corresponding in position to the coolant inlet 25 of the first end board 41, and a second coolant passage 424 corresponding in position to the coolant outlet 26 of the first end board 41. The first gas guide board 42 receives the reaction gas at the first end 421a and guides the reaction gas through the first gas channel 421 to the second end 421b. Preferably, the first gas channel 421, the first coolant passage 423, and the second coolant passage 424 are integrally formed on the first gas guide board 42.

The temperature regulation side partition board 43 forms two coolant passages 432, 433 corresponding in position to the coolant passages 423, 424 of the gas guide board 42 and a gas passage 431 corresponding in position to the second end 421b of the gas channel 421. The temperature regulation side partition board 43 is made of a thermally conductive material, such as an aluminum board. The partition board 43 is used to exchange of heat between the reaction gas and the coolant to regulate the temperature of the reaction gas whereby a temperature-regulated reaction gas is discharged at the second end 421b of the first gas channel 421 of the first gas guide board 42.

The coolant guide board 44 forms at least one coolant channel 441, which in the embodiment illustrated comprises four U-shaped channels that spaced by isolation ribs 442 and are of segments substantially parallel to each other. The U-shaped channel 441 has a third end 441a corresponding in position to the coolant inlet 25 of the first end board 41 and a fourth end 441b corresponding in position to the coolant outlet 26 of the first end board 41. The coolant guide board 44 also defines a first gas passage 443 corresponding in position to the gas passage 431 of the temperature regulation side partition board 43 and the second end 421b of the first gas channel 421 of the first gas guide board 42. The coolant guide board 44 is isolated from the gas guide board 42 by the temperature regulation side partition board 43 that is in physical engagement with both the coolant guide board 44 and the gas guide board 42 for heat transfer purposes. The coolant guide board 44 receives the coolant at the third end 441a and guides the coolant through the coolant channel 441. Preferably, the coolant channel 441 and the first gas passage 443 are integrally formed on the coolant guide board 44.

Air that is supplied from the blower 31 is conducted into the temperature regulation section 4 through the first inlet fitting 21 and the first entry opening 411 of the first end board 41. The air then enters the first end 421a of the gas channel 421 of the first gas guide board 42, and moves along the gas channel 421 to the second end 421b, where air passes, in sequence, through the gas passage 431 of the partition board 43 and the gas passage 443 of the coolant guide board 44. Eventually, air passes through a discharged opening 61 defined in the central partition board 6 that is in physical engagement with the coolant guide board 44.

On the other hand, the coolant discharged from the fuel cell stack 1 is supplied to the device-side coolant inlet 25 and flows into the regulating device 2 sequentially through the coolant passage 423 of the gas guide board 42 and the coolant passage 432 of the partition board 43 to reach the third end 441a of the coolant channel 441 of the coolant guide board 44. The coolant then moves along the coolant channel 441 to the fourth end 441b, where the coolant flows in sequence through the coolant passage 433 of the partition board 43 and the coolant passage 424 of the gas guide board 42. The coolant returns through the device-side coolant outlet 26 and is guided to the cell-side coolant inlet 16 for cooling the fuel cell stack 1 again.

Since the coolant and the air are simultaneously flowing through the coolant channel 441 of the coolant guide board 44 and the gas channel 421 of the first gas guide board 42 and since the coolant guide board 44 and the gas guide board 42, which correspond in position to each other, are both in physical and tight engagement with the temperature regulation side partition board 43 that is made of thermally conductive material to allow for physical contact of the air and the coolant with the partition board 43, heat exchange occurs between the coolant and the air flowing through the first gas guide board 42. Thermal energy flows from the coolant that is of a high temperature around 60-70° C. to the air that is of a lower temperature. Thus, the air is heated and the temperature of the air is increased.

Since the coolant circulation loop is a closed one, the total amount of the coolant flowing through the coolant circulation loop can be substantially preserved. Replenishment of the coolant due to lose in regulating the temperature and humidity of the air supplied to the fuel cell stack 1 is no longer necessary.

The humidity regulation section 5 comprises the second end board 51 opposing the central partition board 6 with a second gas guide board 52, a humidity exchange section 53, and a fluid guide board 54 interposed in sequence. The second gas guide board 52 forms at least one second gas channel 521, which in the embodiment illustrated comprises four U-shaped channels that are spaced by isolation ribs 522 and are of segments substantially parallel to each other. The U-shaped second gas channel 521 has a fifth end 521a corresponding in position to the discharged opening 61 of the central partition board 6 and a sixth end 521b corresponding in position to the first exit opening 511 of the second end board 51. The second gas guide board 52 also defines a first gas passage 523 corresponding in position to the second entry opening 512 of the second end board 51, and a second gas passage 524 corresponding in position to the second exit opening 513 of the second end board 51. The fifth end 521a is arranged in correspondence to the second end 421b of the first gas channel 421 of the first gas guide board 42 via the discharged opening 61 of the central partition board 6 and the first gas passage 443 of the coolant guide board 44 to allow the temperature-regulated reaction gas to flow to the fifth end 521a of the second gas channel 521 of the second gas guide board 52. Preferably, the second gas channel 521, the first gas passage 523, and the second gas passage 524 are integrally formed on the second gas guide board 52.

The fluid guide board 54 forms at least one fluid channel 541, which in the embodiment illustrated comprises four U-shaped channels that are spaced by isolation ribs 542 and are of segments substantially parallel to each other. The U-shaped channel 541 has a seventh end 541a corresponding in position to the first gas passage 523 of the second gas guide board 52 and the second entry opening 512 of the second end board 51 and an eighth end 541b corresponding in position to the second gas passage 524 of the second gas guide board 52 and the second exit opening 513 of the second end board 51. The fluid guide board 54 also defines an air passage 543 corresponding in position to the discharged opening 61 of the central partition board 6 and the fifth end 521a of the second gas channel 521 of the second gas guide board 52. The fluid guide board 54 is isolated from the second gas guide board 52 by the humidity exchange section 43 that is interposed between and in physical engagement with both the fluid guide board 54 and the second gas guide board 52. The fluid guide board 54 receives a fluid rich of water contents discharged from the air outlet 12 of the fuel cell stack 1 at the seventh end 541a and guides the fluid through the fluid channel 541 to the eighth end 541b. Preferably, the fluid channel 541 and the air passage 543 are integrally formed on the fluid guide board 54.

The humidity exchange section 53 is humidity exchange film comprising a humidity exchange film 531 interposed between gas diffusion layers 532, 533 and supported by the isolation ribs 522 of the second gas guide board 52 and the isolation ribs 542 of the fluid guide board 54, which are respectively in physical and tight engagement with the second gas guide board 52 and the fluid guide board 54 to allow physical contact of the air flowing through the second gas channel 521 and the fluid flowing through the fluid channel 541. The humidity exchange section 53 is of a size that is sufficient to cover the fluid channel 541 of the fluid guide board 54 and the second gas channel 521 of the second gas guide board 52. However, the fifth and sixth ends 521a, 521b of the second gas channel 521 are shielded by the humidity exchange section 53 and thus air that flows through the discharged openings 61 of the central partition board 6 is allowed to freely flow into the fifth end 521a of the second gas guide board 52. The humidity exchange section 53 does not shield the gas passages 523, 524 of the second gas guide board 52.

Air of which temperature has been regulated in the temperature regulation section 4 flows through the discharged opening 61 of the central partition board 6, and the air passage 543 of the fluid guide board 54 to reach the fifth end 521a of the second gas guide board 52. The air then moves along the second gas channel 521 to the sixth end 521b, where air passes through the first exit opening 511 and the first outlet fitting 22 for supply to the fuel cell stack 1 through the air inlet 11 of the fuel cell stack 1.

On the other hand, the fluid rich of water contents that is discharged from the air outlet 12 of the fuel cell stack 1 is supplied to the second inlet fitting 23 of the regulating device 2 and flows into the seventh end 541a of the fluid guide board 54 sequentially through the second entry opening 512 of the second end board 51 and the gas passage 523 of the second gas guide board 52. The fluid then moves along the fluid channel 541 to the eighth end 541b, where the fluid flows in sequence through the gas passage 524 of the second gas guide board 52 and the second exit opening 513 of the second end board 53 and is then discharged out of the regulating device 2 via the second outlet fitting 24.

The air of which the temperature has been regulated by the temperature regulation section 4 enters the humidity regulation section 5 in which the air is subject to regulation of humidity thereof by exchange of humidity with the fluid from the fuel cell stack 1, which is rich of water contents, whereby the air may absorb water from the fluid and the relative humidity of the air may be increased to a desired range for enhancing the chemical reaction inside the fuel cell stack 1.

Thus, air that is drawn in a fuel cell system comprised of the regulating device of the present invention, such as the one illustrated in FIG. 7, is subject to regulation of both temperature and relative humidity whereby chemical reaction and thus the performance of the fuel cell system is maintained optimum.

The first gas channel 421, the coolant channel 441,.the fluid channel 541, and the second gas channel 521 are in U-shaped channel form as illustrated, which may be replaced by the other structure, such as parallel flow field, serpentine flow filed, symmetric serpentine flow filed, interdigitated flow field, wire mesh, metal foam and lattice form, in application.

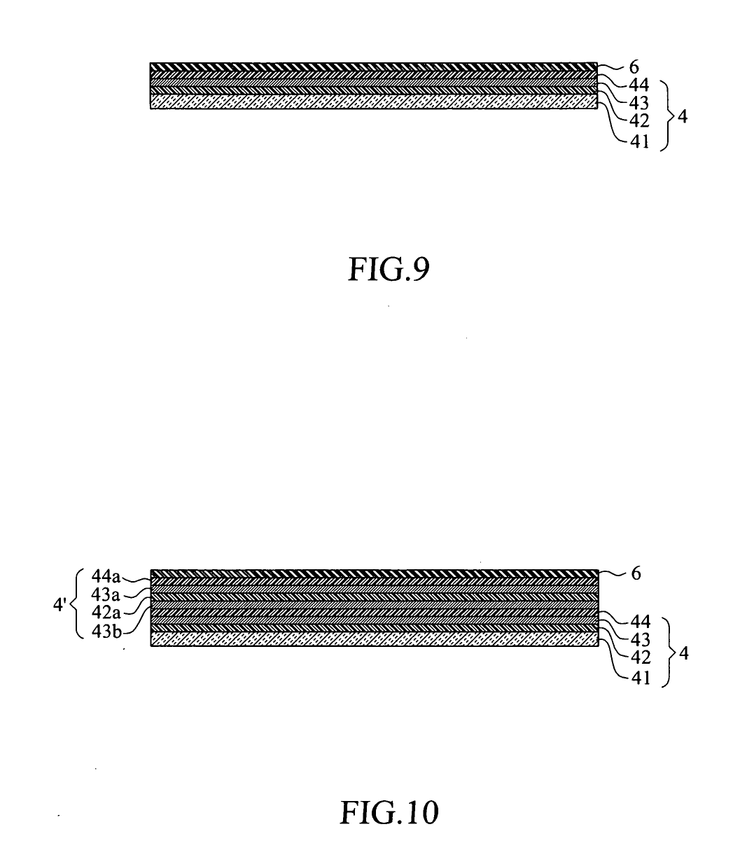

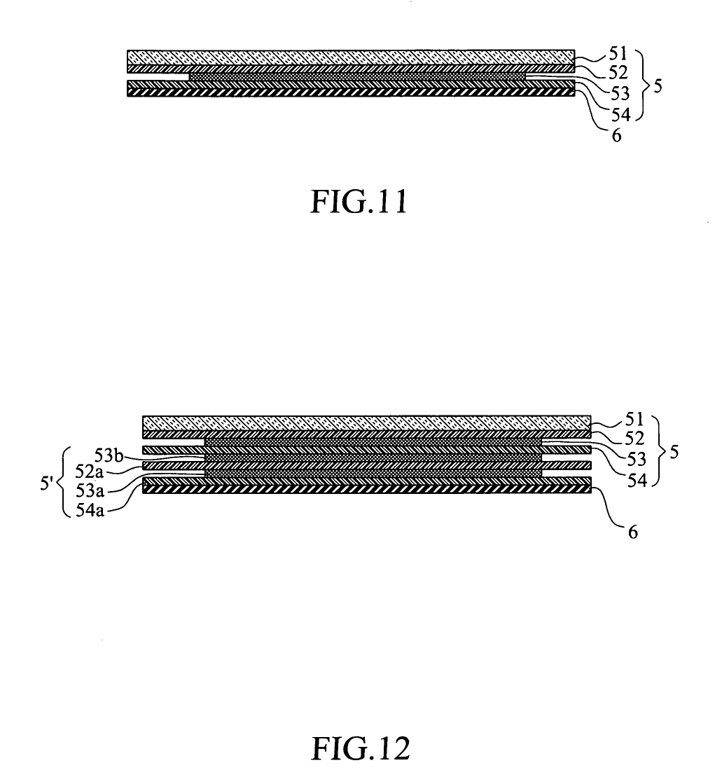

Also referring to FIGS. 9 and 11, which show cross-sectional views of the temperature regulation section 4 and the humidity regulation section 5 described above. The temperature regulation section 4 illustrated and described above may serve as a temperature regulation unit and a number of temperature regulation units may be combined as a compound multi-unit temperature regulation means for a reaction gas temperature and humidity regulating device embodying the present invention. FIG. 10 shows a two-unit temperature regulation means comprising two temperature regulation units stacked together, each having a construction substantially identical to the temperature regulation section 4 described with reference to FIG. 8. As shown in FIG. 10, a first temperature regulation section 4 comprised of a gas guide board 42, a partition board 43, and a coolant guide board 44 is stacked on a second temperature regulation section comprised of a gas guide board 42a, a partition board 43b, and a coolant guide board 44a with a further partition board 43a interposed between the first and second temperature regulation sections and in contact with the coolant guide board 44 and the gas guide board 42a. Such a structure can be repeated with an additional partition board interposed between adjacent ones of the temperature regulation sections.

Similarly, the humidity regulation section 5 can server as a basic unit for constitute a humidity regulation unit and a number of humidity regulation units may be combined as a compound multi-unit humidity regulation means for a reaction gas temperature and humidity regulating device embodying the present invention. FIG. 12 shows a two-unit humidity regulation means comprising two humidity regulation units stacked together, each having a construction substantially identical to the humidity regulation section 5 described with reference to FIG. 8. As shown in FIG. 12, a first humidity regulation section 5 comprised of a gas guide board 52, a humidity exchange section 53, and a fluid guide board 54 is stacked on a second humidity regulation section comprised of a gas guide board 52a, a humidity exchange section 53a, and a fluid guide board 54a with a further humidity exchange section 53b interposed between the first and second humidity regulation sections and in contact with the fluid guide board 54 and the gas guide board 52a. Such a structure can be repeated with an additional humidity exchange section interposed between adjacent ones of the humidity regulation sections.

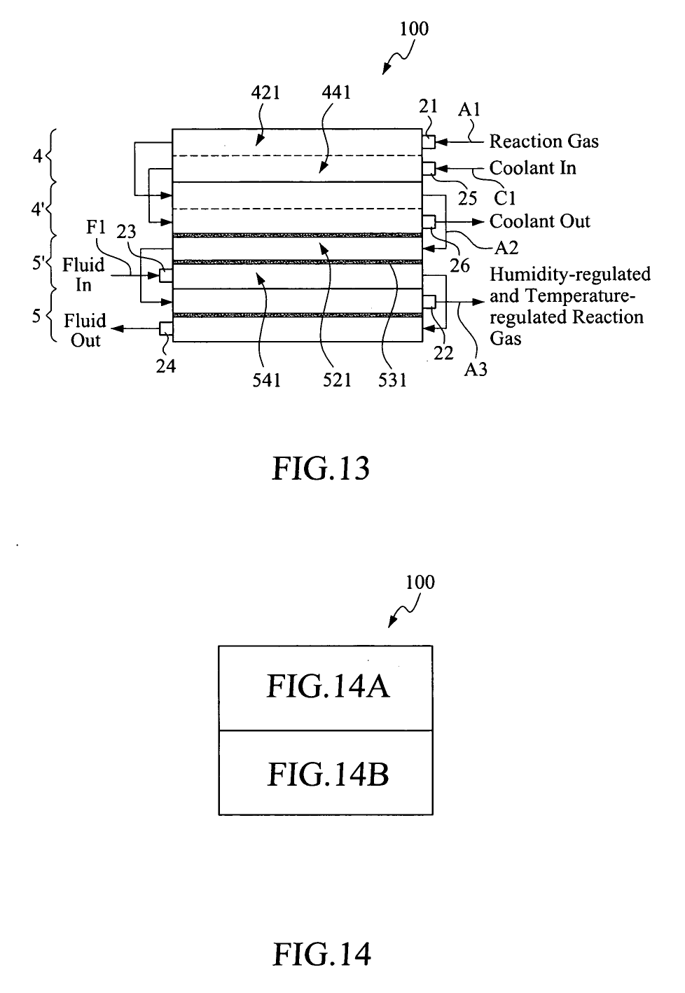

FIG. 13 is a schematic view showing a reaction gas temperature and humidity regulating stack 100 composed of a plurality of basic temperature regulation sections 4 and a plurality of extended humidity regulation sections 5 in accordance with a third embodiment of the present invention. In this embodiment, the reaction gas temperature and humidity regulating stack 100 is composed of a plurality of stacked temperature regulation sections 4, 4′ and a plurality of stacked humidity regulation sections 5, 5′.

Each of the temperature regulation sections 4 comprises at least one first gas channel 421 and at least one coolant channel 441. A reaction gas A1 is conducted into the reaction gas temperature and humidity regulating stack 100 through the first gas channel 421. The coolant channel 441 is in fluid communication between the coolant outlet 15 and the coolant inlet 16 of the fuel cell stack 1, for exchange of heat between the reaction gas A1 flowing through the first gas channel 421 and the coolant C1 flowing through the coolant channel 441 to regulate temperature of the reaction gas A1 whereby a temperature-regulated reaction gas A2 is discharged from an output end of the first gas channel 421. The coolant C1 returns through the coolant outlet 26 and is guided to the coolant inlet 16 of the fuel cell stack 1.

Each of the humidity regulation sections 5 comprises at least one second gas channel 521 in fluid communication with the air inlet 11 of the fuel cell stack 1 and at least one fluid channel 541 in fluid communication with the air outlet 12 of the fuel cell stack 1. The temperature-regulated reaction gas A2 discharged from the temperature regulation sections 4 is conducted into the second gas channel 521 of the humidity regulation sections 5. A fluid F1 rich of water contents discharged from the air outlet 12 of the fuel cell stack 1 is conducted into the fluid channel 541.

At least one humidity exchange film 531 is in contact with the temperature-regulated reaction gas A2 flowing through the second gas channel 521 and the fluid F1 flowing through the fluid channel 541, for exchange of water contents between the temperature-regulated reaction gas A2 and the fluid F1, whereby a humidity-regulated and temperature-regulated reaction gas A3 is discharged to the air inlet 11 of the fuel cell stack 1 through the second gas channel 521 and the first outlet fitting 22.

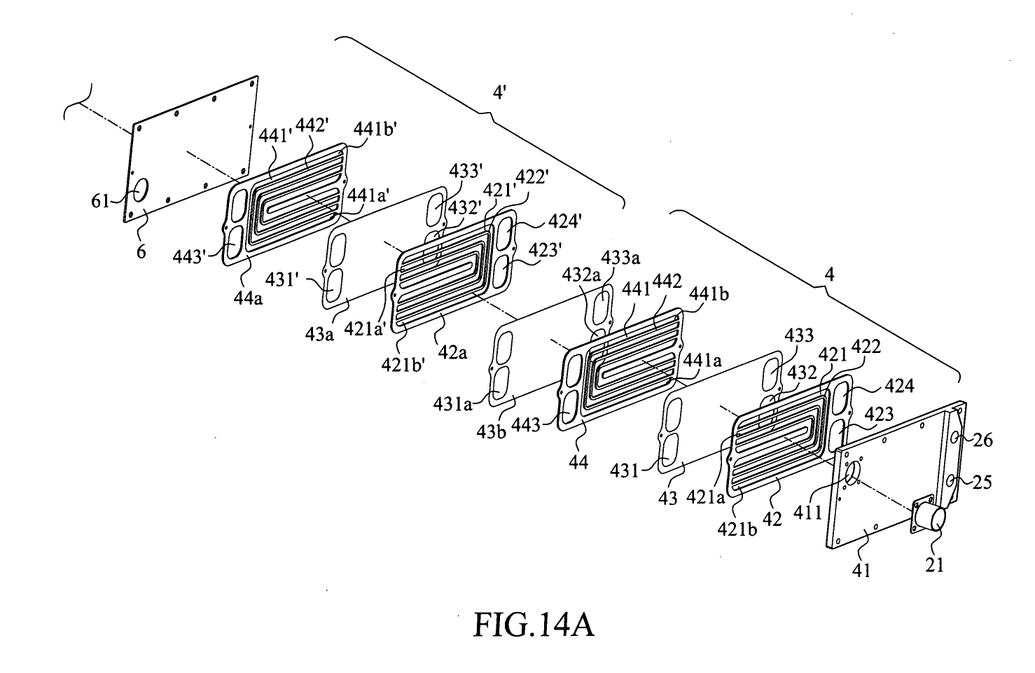

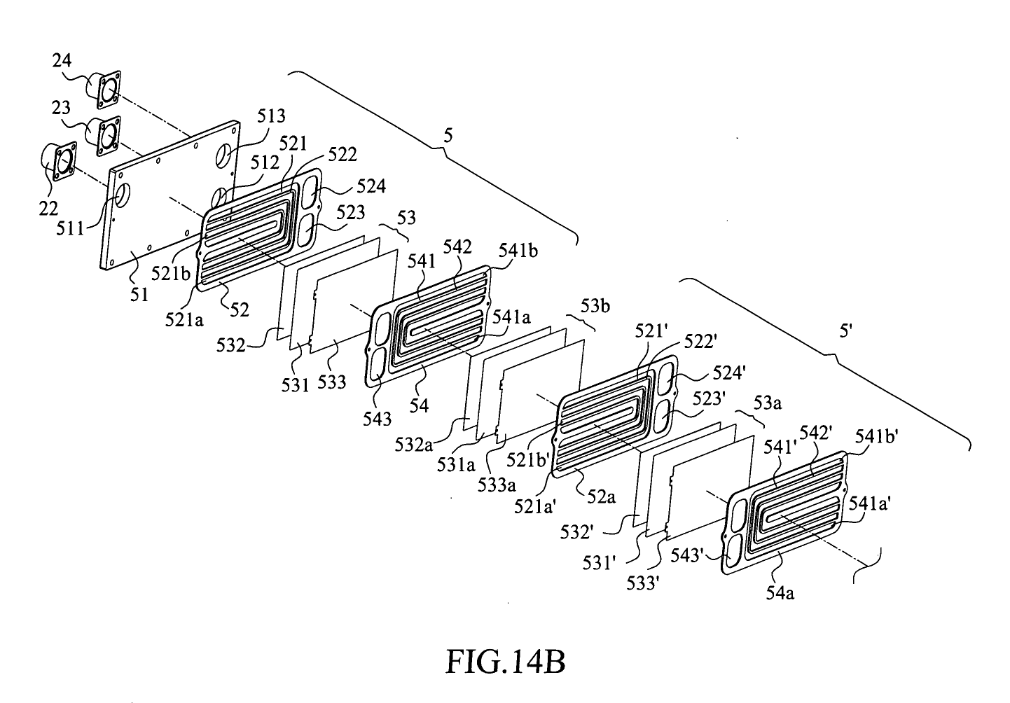

FIG. 14A is an exploded view showing two temperature regulation sections 4, 4′ are stacked in sequence in accordance with the third embodiment shown in FIG. 13, and FIG. 14B is an exploded view showing two humidity regulation sections 5, 5′ are stacked in accordance with the third embodiment shown in FIG. 13. More than one extended temperature regulation section 4′ may be stacked to the basic temperature regulation section 4 and more than one extended humidity regulation section 5′ may be stacked to the basic humidity regulation section 5 in application.

Similar to the basic temperature regulation section 4 as illustrated in the first embodiment shown in FIG. 8, the extended temperature regulation section 4′ comprises a first gas guide board 42a, a partition board 43a and a coolant guide board 44a. A partition board 43b is further interposed between the basic temperature regulation section 4 and the extended temperature regulation section 4′.

The first gas guide board 42a of the extended temperature regulation section 4′ is provided with one first gas channel 421′ with a first end 421a′ and a second end 421b′, a plurality of isolation ribs 422′, a pair of coolant passages 423′, 424′. The partition board 43a is provided with at least one gas passage 431′, and a pair of coolant passages 432′, 433′. The coolant guide board 44a is provided with a coolant channel 441′ with a third end 441a′ and a fourth end 441b′, a plurality of isolation ribs 442′, at least one gas passage 443′ corresponding in position to the discharged opening 61 of the central partition board 6.

Similar to the basic humidity regulation section 5 as illustrated in the first embodiment shown in FIG. 8, the extended humidity regulation section 5′ comprises a second gas guide board 52a, a humidity exchange section 53a, and a fluid guide board 54a interposed in sequence. A humidity exchange section 53b composed of a humidity exchange film 531a interposed between gas diffusion layers 532a, 533a is further interposed between the basic humidity regulation section 5 and the extended humidity regulation section 5′.

The second gas guide board 52a is provided with the second gas channel 521′ with a fifth end 521a′ and a sixth end 521b′, a plurality of isolation ribs 522′, a pair of gas passages 523′, 524′. The humidity exchange section 53a is provided with a humidity exchange film 531′ interposed between gas diffusion layers 532′, 533′. The fluid guide board 54a is provided with a fluid channel 541′ with a seventh end 541a′ and an eighth end 541b′, a plurality of isolation ribs 542′, at least one gas passage 543′ corresponding in position to the discharged opening 61 of the central partition board 6 as shown in FIG. 14A.

In the third embodiment of the present invention as shown in FIG. 13, the reaction gas A1 is first heated by the stacked temperature regulation sections 4, 4′ and humidified by the stacked humidity regulation sections 5, 5′ to supply the temperature-regulated and humidity-regulated reaction gas A3 to the fuel cell stack. Alternatively, it is possible to first humidify the reaction gas A1 by the stacked humidity regulation sections 5, 5′ and heated by the stacked temperature regulation sections 4, 4′ to supply the humidity-regulated and temperature-regulated reaction gas A3 to the fuel cell stack.

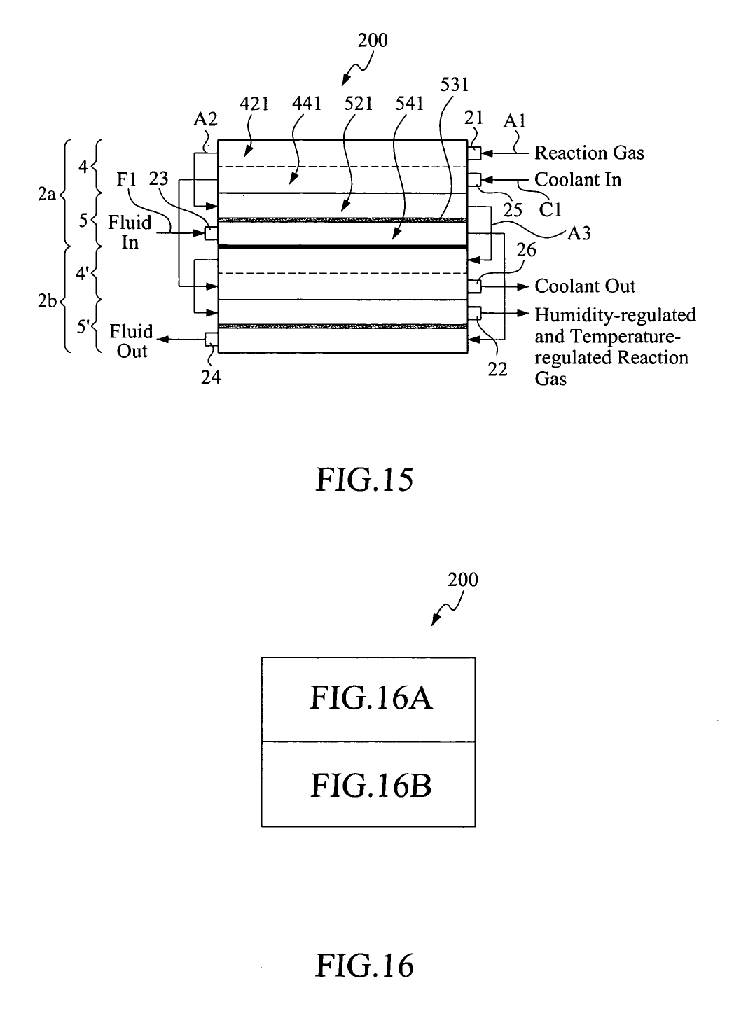

FIG. 15 is a schematic view showing a reaction gas temperature and humidity regulating stack 200 composed of a plurality of stacked temperature and humidity regulation devices 2a, 2b in accordance with a fourth embodiment of the present invention. In this embodiment, the reaction gas temperature and humidity regulating stack 200 is composed of a first stage temperature and humidity regulation device 2a and a second stage temperature and humidity regulation device 2b.

The first stage temperature and humidity regulation device 2a comprises a temperature regulation section 4 and a humidity regulation section 5. The temperature regulation section 4 comprises at least one first gas channel 421, a reaction gas A1 being conducted into the temperature and humidity regulation stack 200 through the first gas channel 421; and at least one coolant channel 441 in fluid communication between the coolant outlet 15 and the coolant inlet 16 of the fuel cell stack 1, for exchange of heat between the reaction gas A1 flowing through the first gas channel 421 and a coolant C1 flowing through the coolant channel 441 to regulate temperature of the reaction gas A1 whereby a temperature-regulated reaction gas A2 is discharged at an output end of the first gas channel 421.

The humidity regulation section 5 in the first stage temperature and humidity regulation device 2a comprises a second gas channel 521 in fluid communication with the first gas channel 421, the temperature-regulated reaction gas A2 being conducted into the second gas channel 521. A fluid channel 541 is in fluid communication with the air outlet 12 of the fuel cell stack 1, a fluid rich of water contents discharged from the air outlet 12 of the fuel cell stack 1 being conducted into the fluid channel 541. A humidity exchange film 531 is in contact with the temperature-regulated reaction gas A2 flowing through the second gas channel 521 and the fluid F1 flowing through the fluid channel 541, for exchange of water contents between the temperature-regulated reaction gas A2 and the fluid F1, whereby a humidity-regulated and temperature-regulated reaction gas A3 is discharged at an output end of the second gas channel 521.

The second stage reaction gas temperature and humidity regulating device 2b comprises a temperature regulation section 4′ and a humidity regulation section 5′. The structure of the temperature regulation section 4′ is same to that of the temperature regulation section 4 of the first stage temperature and humidity regulation device 2a, and the structure of the humidity regulation section 5′ is same to that of the humidity regulation section 5 of the first stage temperature and humidity regulation device 2a.

The humidity-regulated and temperature-regulated reaction gas A3 discharged from the first stage temperature and humidity regulation device 2a is further conducted into the temperature regulation section 4′ and the humidity regulation section 5′ of the second stage reaction gas temperature and humidity regulating device 2b, for exchange of heat between the reaction gas flowing through the first gas channel and the coolant flowing through the coolant channel of the second stage reaction gas temperature and humidity regulating device 2b and for exchange of water contents between the temperature-regulated reaction gas and the fluid of the second -stage reaction gas temperature and humidity regulating device 2b, whereby a humidity-regulated and temperature-regulated reaction gas is discharged at an output end of the second gas channel of the second stage reaction gas temperature and humidity regulating device 2b, and finally supplied through the first outlet fitting 22 of the humidity regulation section 5′ of the second stage reaction gas temperature and humidity regulating device 2b to the air inlet 11 of the fuel cell stack 1.

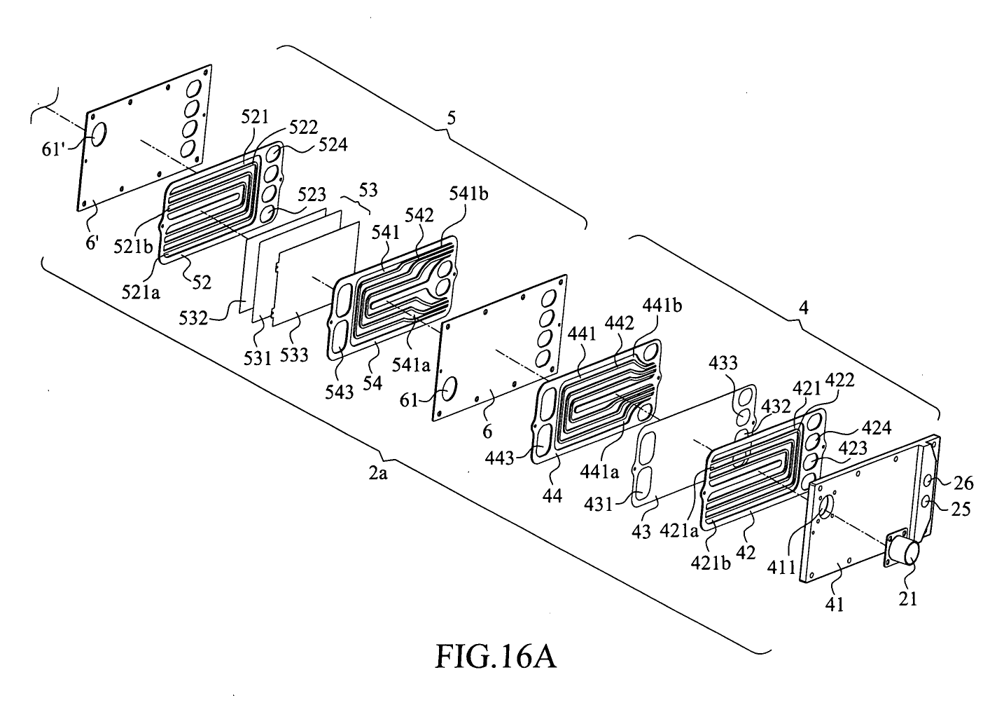

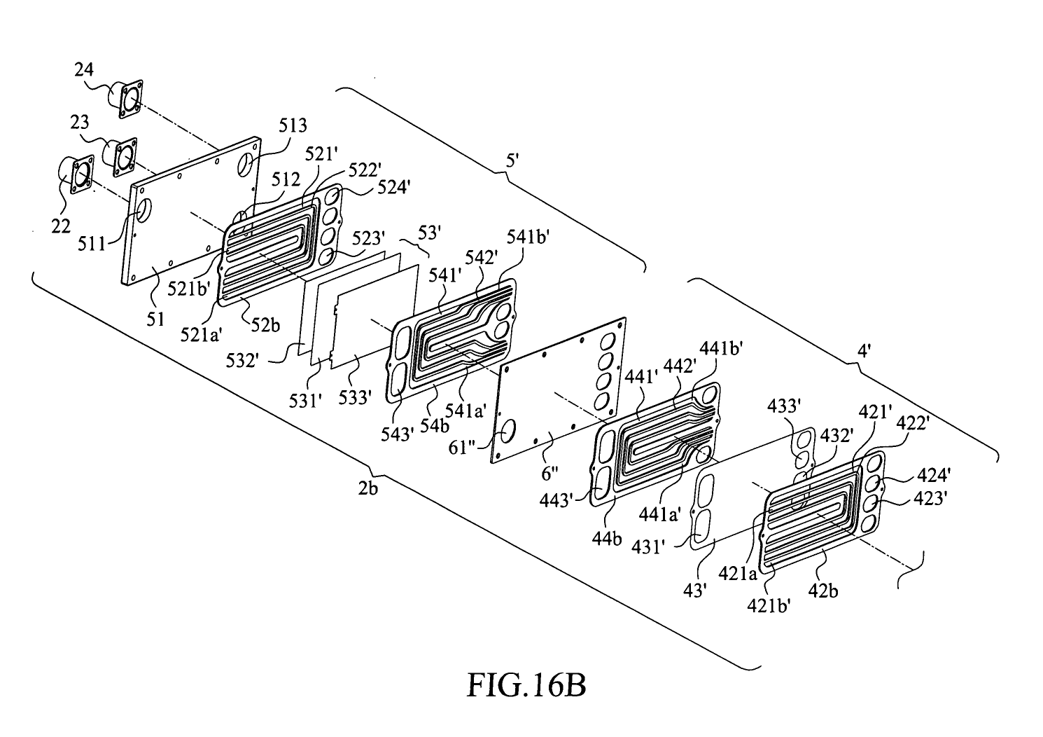

FIG. 16A is an exploded view showing a basic temperature regulation section 4 and a basic humidity regulation section 5 are stacked in sequence in accordance with the fourth embodiment shown in FIG. 15, and FIG. 16B is an exploded view showing an extended temperature regulation section 4′ and an extended humidity regulation section 5′ are stacked in accordance with the fourth embodiment shown in FIG. 15. The basic temperature regulation section 4 and the basic humidity regulation section 5 as shown in FIG. 16A are stacked together to form a first stage reaction gas temperature and humidity regulating device 2a, and the extended basic temperature regulation section 4′ and the extended humidity regulation section 5′ as shown in FIG. 16B are stacked together to form a second stage reaction gas temperature and humidity regulating device 2b.

As shown in FIG. 16A and FIG. 16B, a central partition board 6′ with a discharged opening 61′ is further interposed between the first stage reaction gas temperature and humidity regulating device 2a and the second stage reaction gas temperature and humidity regulating device 2b. A central partition board 6 with a discharged opening 61 is interposed between the basic temperature regulation section 4 and the basic humidity regulation section 5. A central partition board 6″ with a discharged opening 61″ is interposed between the extended temperature regulation section 4′ and the extended humidity regulation section 5′.

In this embodiment, the structure and function of the basic temperature regulation section 4 and the basic humidity regulation section 5 are same to that of the temperature regulation section 4 and the humidity regulation section 5 as shown in FIG. 8 respectively, to supply a first stage temperature-regulated and humidity-regulated air at the discharged opening 61′ of the central partition board 6′. The structure and function of the extended temperature regulation section 4′ and the extended humidity regulation section 5′ are also same to that of the temperature regulation section 4 and the humidity regulation section 5 as shown in FIG. 8 respectively. The second stage reaction gas temperature and humidity regulating device 2b is designed to receive the first stage temperature-regulated and humidity-regulated air discharged from the first stage reaction gas temperature and humidity regulating device 2a and further discharge a second stage temperature-regulated and humidity-regulated air at the first exit opening 511 of the second end boards 51, and finally supply through the first outlet fitting 22 to the air inlet 11 of the fuel cell stack 1.

In the fourth embodiment of the present invention as shown in FIG. 15, the reaction gas A1 is first heated then humidified by the temperature and humidity regulation sections 4, 5 and 4′, 5′ in each stage of temperature and humidity regulation devices to supply the humidity-regulated and temperature-regulated reaction gas A3 to the fuel cell stack. Alternatively, it is possible to first humidify then heat the reaction gas A1 by the humidity and temperature regulation sections 5, 4 and 5′, 4′ in each stage of temperature and humidity regulation devices to supply the humidity-regulated and temperature-regulated reaction gas A3 to the fuel cell stack.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A fuel cell system comprising:
a fuel cell stack having an air inlet, an air outlet, a coolant inlet and a coolant outlet;
a reaction gas temperature and humidity regulating stack coupled to the fuel cell stack for regulating temperature and humidity of a reaction gas to be supplied to the air inlet of the fuel cell stack, comprising:
a plurality of stacked temperature regulation sections, each of which comprising: at least one first gas channel, the reaction gas being conducted into the reaction gas temperature and humidity regulating stack through the first gas channel; and at least one coolant channel in fluid communication between the coolant outlet and the coolant inlet of the fuel cell stack, for exchange of heat between the reaction gas flowing through the first gas channel and the coolant flowing through the coolant channel to regulate temperature of the reaction gas whereby a temperature-regulated reaction gas is discharged; and
a plurality of stacked humidity regulation sections, each of which comprising: at least one second gas channel in fluid communication with the air inlet of the fuel cell stack, the temperature-regulated reaction gas being conducted into the second gas channel; at least one fluid channel in fluid communication with the air outlet of the fuel cell stack, a fluid rich of water contents discharged from the air outlet of the fuel cell stack being conducted into the fluid channel; and at least one humidity exchange film being in contact with the temperature-regulated reaction gas flowing through the second gas channel and the fluid flowing through the fluid channel, for exchange of water contents between the temperature-regulated reaction gas and the fluid, whereby a humidity-regulated and temperature-regulated reaction gas is discharged to the air inlet of the fuel cell stack through the second gas channel.

2. The fuel cell system as claimed in claim 1, wherein the reaction gas temperature and humidity regulating stack comprises:
a first end board defining a first entry opening, a coolant inlet in fluid communication with the coolant outlet of the fuel cell stack, and a coolant outlet in fluid communication with the coolant inlet of the fuel cell stack, the reaction gas being conducted into the first entry opening;
a second end board defining a first exit opening in fluid communication with the air inlet of the fuel cell stack, a second entry opening in fluid communication with the air outlet of the fuel cell stack, and a second exit opening; and
the temperature regulation sections and the humidity regulation sections being disposed between the first end board and the second end board.

3. The fuel cell system as claimed in claim 2, a central partition board being further interposed between the temperature regulation sections and the humidity regulation sections.

4. The fuel cell system as claimed in claim 2, wherein the temperature regulation section comprises:
a first gas guide board formed with the first gas channel having a first end corresponding in position to the first entry opening of the first end board, a second end, a first coolant passage corresponding in position to the coolant inlet of the first end board, a second coolant passage corresponding in position to the coolant outlet of the first end board; the first gas channel comprising a plurality of channels substantially parallel to each other, spaced apart by isolation ribs, the first gas guide board receiving the reaction gas at the first end and guiding the reaction gas through the first gas channel to the second end;
a coolant guide board formed with the coolant channel having a third end corresponding in position to the coolant inlet of the first end board, a fourth end corresponding in position to the coolant outlet of the first end board, a first gas passage corresponding in position to the second end of the first gas channel of the first gas guide board; the coolant guide board comprising a plurality of channels substantially parallel to each other, spaced apart by isolation ribs, the coolant guide board receiving the coolant at the third end and guiding the coolant through the coolant channel; and
a partition board interposed between the first gas guide board and the coolant guide board, having a pair of coolant passages corresponding in position to the coolant passages of the gas guide board respectively and a gas passage corresponding in position to the second end of the gas channel and the first gas passage of the coolant guide board.

5. The fuel cell system as claimed in claim 4, wherein the first gas channel, the first coolant passage, and the second coolant passage are integrally formed on the first gas guide board.

6. The fuel cell system as claimed in claim 4, wherein the coolant channel and the first gas passage are integrally formed on the coolant guide board.

7. The fuel cell system as claimed in claim 2, wherein the humidity regulation section comprises:
a second gas guide board formed with the second gas channel having a fifth end corresponding in position to a discharged opening, a sixth end corresponding in position to the first exit opening of the second end board, a first gas passage corresponding in position to the second entry opening of the second end board, a second gas passage corresponding in position to the second exit opening of the second end board; the fifth end corresponding in position to the second end of the first gas channel of the first gas guide board via the discharged opening and the first gas passage of the coolant guide board to allow the temperature-regulated reaction gas to flow to the sixth end of the second gas channel of the second gas guide board, the second gas channel comprising a plurality of channels substantially parallel to each other, spaced apart by isolation ribs, the second gas guide board receiving the temperature-regulated reaction gas at the fifth end via the discharged opening and guiding the temperature-regulated reaction gas through the second gas channel to the sixth end;
a fluid guide board formed with the fluid channel having a seventh end corresponding in position to the first gas passage of the second gas guide board and the second entry opening of the second end board, an eighth end corresponding in position to the second gas passage of the second gas guide board and the second exit opening of the second end board, an air passage corresponding in position to the fifth end of the second gas guide board; the fluid guide board comprising a plurality of channels substantially parallel to each other, spaced apart by isolation ribs, the fluid guide board receiving a fluid rich of water contents discharged from the air outlet of the fuel cell stack at the seventh end and guide the fluid through the fluid channel to the eighth end; and
a humidity exchange section interposed between the second gas guide board and the fluid guide board, the humidity exchange film being supported between the isolation ribs of the second gas guide board and the isolation ribs of the fluid guide board.

8. The fuel cell system as claimed in claim 7, wherein the humidity exchange film is interposed between two gas diffusion layers that are in contact with the reaction gas flowing through the second gas channel of the second gas guide board and the fluid flowing through the fluid channel of the fluid guide board.

9. The fuel cell system as claimed in claim 7, wherein the second gas guide board defines a plurality of spaced and substantially parallel gas channels and wherein the fluid guide board defines a plurality of spaced and substantially parallel fluid channels.

10. The fuel cell system as claimed in claim 7, wherein the second gas channel, the first gas passage, and the second gas passage are integrally formed on the second gas guide board.

11. The fuel cell system as claimed in claim 7, wherein the fluid channel and the air passage are integrally formed on the fluid guide board.

12. A fuel cell system comprising:
a fuel cell stack having an air inlet, an air outlet, a coolant inlet and a coolant outlet;
a reaction gas temperature and humidity regulating stack coupled to the fuel cell stack for regulating temperature and humidity of a reaction gas and supplying a humidity-regulated and temperature-regulated reaction gas to the air inlet of the fuel cell stack, comprising a plurality of temperature and humidity regulation devices, each of the temperature and humidity regulation devices comprising:
a temperature regulation section comprising: at least one first gas channel, the reaction gas being conducted into the temperature regulation section through the first gas channel; and at least one coolant channel in fluid communication between the coolant outlet and the coolant inlet of the fuel cell stack, for exchange of heat between the reaction gas flowing through the first gas channel and the coolant flowing through the coolant channel to regulate temperature of the reaction gas whereby a temperature-regulated reaction gas is discharged; and
a humidity regulation section comprising: at least one second gas channel to humidify the temperature-regulated reaction gas for supplying the fuel cell stack, the temperature-regulated reaction gas being conducted into the second gas channel; at least one fluid channel in fluid communication with the air outlet of the fuel cell stack, a fluid rich of water contents discharged from the air outlet of the fuel cell stack being conducted into the fluid channel; and at least one humidity exchange film being in contact with the temperature-regulated reaction gas flowing through the second gas channel and the fluid flowing through the fluid channel, for exchange of water contents between the temperature-regulated reaction gas and the fluid, and thereby discharging the humidity-regulated and temperature-regulated reaction gas through the second gas channel.

13. The fuel cell system as claimed in claim 12, wherein the reaction gas temperature and humidity regulating stack comprises:
a first end board defining a first entry opening, a coolant inlet in fluid communication with the coolant outlet of the fuel cell stack, and a coolant outlet in fluid communication with the coolant inlet of the fuel cell stack, the reaction gas being conducted into the first entry opening;
a second end board defining a first exit opening in fluid communication with the air inlet of the fuel cell stack, a second entry opening in fluid communication with the air outlet of the fuel cell stack, and a second exit opening;
the temperature and humidity regulation devices being interposed between the first end board and the second end board.

14. The fuel cell system as claimed in claim 13, a central partition board being further interposed between the temperature and humidity regulation devices.

15. The fuel cell system as claimed in claim 13, wherein the temperature regulation section comprises:
a first gas guide board formed with the first gas channel having a first end corresponding in position to the first entry opening of the first end board, a second end, a first coolant passage corresponding in position to the coolant inlet of the first end board, a second coolant passage corresponding in position to the coolant outlet of the first end board; the first gas channel comprising a plurality of channels substantially parallel to each other, spaced apart by isolation ribs, the first gas guide board receiving the reaction gas at the first end and guiding the reaction gas through the first gas channel to the second end;
a coolant guide board formed with the coolant channel having a third end corresponding in position to the coolant inlet of the first end board, a fourth end corresponding in position to the coolant outlet of the first end board, a first gas passage corresponding in position to the second end of the first gas channel of the first gas guide board; the coolant guide board comprising a plurality of channels substantially parallel to each other, spaced apart by isolation ribs, the coolant guide board receiving the coolant at the third end and guiding the coolant through the coolant channel; and
a partition board interposed between the first gas guide board and the coolant guide board, having a pair of coolant passages corresponding in position to the coolant passages of the gas guide board respectively and a gas passage corresponding in position to the second end of the gas channel and the first gas passage of the coolant guide board.

16. The fuel cell system as claimed in claim 15, wherein the first gas channel, the first coolant passage, and the second coolant passage are integrally formed on the first gas guide board.

17. The fuel cell system as claimed in claim 15, wherein the coolant channel and the first gas passage are integrally formed on the coolant guide board.

18. The fuel cell system as claimed in claim 13, wherein the humidity regulation section comprises:
a second gas guide board formed with the second gas channel having a fifth end corresponding in position to a discharged opening, a sixth end corresponding in position to the first exit opening of the second end board, a first gas passage corresponding in position to the second entry opening of the second end board, a second gas passage corresponding in position to the second exit opening of the second end board; the fifth end corresponding in position to the second end of the first gas channel of the first gas guide board via the discharged opening and the first gas passage of the coolant guide board to allow the temperature-regulated reaction gas to flow to the sixth end of the second gas channel of the second gas guide board, the second gas channel comprising a plurality of channels substantially parallel to each other, spaced apart by isolation ribs, the second gas guide board receiving the temperature-regulated reaction gas at the fifth end via the discharged opening and guiding the temperature-regulated reaction gas through the second gas channel to the sixth end;
a fluid guide board formed with the fluid channel having a seventh end corresponding in position to the first gas passage of the second gas guide board and the second entry opening of the second end board, an eighth end corresponding in position to the second gas passage of the second gas guide board and the second exit opening of the second end board, an air passage corresponding in position to the fifth end of the second gas guide board; the fluid guide board comprising a plurality of channels substantially parallel to each other, spaced apart by isolation ribs, the fluid guide board receiving a fluid rich of water contents discharged from the air outlet of the fuel cell stack at the seventh end and guide the fluid through the fluid channel to the eighth end; and
a humidity exchange section interposed between the second gas guide board and the fluid guide board, the humidity exchange film being supported between the isolation ribs of the second gas guide board and the isolation ribs of the fluid guide board.

19. The fuel cell system as claimed in claim 18, wherein the humidity exchange film is interposed between two gas diffusion layers that are in contact with the reaction gas flowing through the second gas channel of the second gas guide board and the fluid flowing through the fluid channel of the fluid guide board.

20. The fuel cell system as claimed in claim 18, wherein the second gas guide board defines a plurality of spaced and substantially parallel gas channels and wherein the fluid guide board defines a plurality of spaced and substantially parallel fluid channels.

21. The fuel cell system as claimed in claim 18, wherein the second gas channel, the first gas passage, and the second gas passage are integrally formed on the second gas guide board.

22. The fuel cell system as claimed in claim 18, wherein the fluid channel and the air passage are integrally formed on the fluid guide board.
